(19) United States
(12) Patent Application Publication
(10) Pub. No.: US 2013/0097981 A1
(43) Pub. Date: Apr. 25, 2013

(54) REMOVABLE RADIATOR BRACKET FILTER SYSTEMS

(71) Applicant: Doug G. Harris, Justin, TX (US)

(72) Inventor: Doug G. Harris, Justin, TX (US)

(21) Appl. No.: 13/653,914

(22) Filed: Oct. 17, 2012

Related U.S. Application Data
(60) Provisional application No. 61/550,161, filed on Oct. 21, 2011.

(51) Int. Cl. B01D 46/10

(52) U.S. Cl. 55/495

(57) ABSTRACT

Different forms of filter systems may be provided to accommodate attaching different types of radiator pumps. A user may easily insert and/or remove a filter from each filter system, such as for cleaning or replacement, thereby minimizing downtime as well as the possibility of overheating. Removable radiator bracket filter systems may be provided in three styles—old, new and combo. In the old style, receiving portions (or panels) may each include two tabs having apertures for connecting the filter system to a pump. In the new style, the top and bottom portions may each include two tabs having apertures for connecting the filter system to a pump. In the combo style, receiving portions as well as top and bottom portions forming a frame each may include two tabs having apertures.

### CROSS-REFERENCE TO RELATED APPLICATIONS

This application claims the benefit of U.S. Provisional Application No. 61,550,161, entitled “Removable Radiator Bracket Filter Systems,” filed Oct. 21, 2011, which is incorporated herein by reference in its entirety.

### FIELD OF THE DISCLOSURE

The present disclosure generally relates to filter systems, and more particularly to removable radiator bracket filter systems.

### BACKGROUND

Radiator filter systems require regular cleaning in order to avoid possible overheating given that they may sometimes be in constant operation. Sometimes this cleaning may not occur as regularly as it should as it can be costly and time-consuming insofar as the radiator system may have to be put on hold in order to perform such cleaning. In addition, it often may be difficult to remove and then replace a filter in a filter system in order to perform such cleaning.

### SUMMARY

Embodiments of the present disclosure may provide removable radiator bracket filter systems that may include three forms—old-style, new-style and combo-style. Different forms of filter systems may be provided to accommodate attaching different types of radiator pumps. In each type of filter system according to embodiments of the present disclosure, a user may easily insert and/or remove a filter from the filter system, such as for cleaning or replacement, thereby minimizing downtime as well as the possibility of overheating.

Filter systems according to embodiments of the present disclosure may include a top portion and a bottom portion that may be placed in parallel and connected by two receiving portions that are in parallel, thereby forming a frame shape. In an old-style filter system, receiving portions (or panels) may each include two tabs having apertures for connecting the filter system to a pump according to embodiments of the present disclosure. In a new-style filter system, the top and bottom portions may each include two tabs having apertures for connecting the filter system to a pump according to embodiments of the present disclosure. In a combo-style filter system, receiving portions as well as the top and bottom portions each may include two tabs having apertures to connect the filter system to a pump according to embodiments of the present disclosure.

An embodiment of the present disclosure may provide a removable radiator bracket filter system comprising a body having a top edge with an opening through which a filter may be received, and receiving portions joining with the top edge and a bottom edge to form a frame, the receiving portions having a ledge-shape to receive the sides of the filter and including extension portions that may protrude from the receiving portions. The bottom edge may be shaped in a tray formation to receive the filter. Each of the extension portions may include a U-shaped curved portion at the end opposite the joining point between the receiving portion and the extension portion. Each of the extension portions may include aperture tabs positioned on opposing sides of the U-shaped curved portion to attach the filter system to a pump.

In another embodiment of the present disclosure, a removable radiator bracket filter system may comprise a top portion and a bottom portion in parallel to each other with receiving portions in parallel to each other and joining with the top portion and the bottom at a right angle, the top portion, the bottom portion and the receiving portions forming a frame, wherein the top portion and the bottom portion each may include tab portions having apertures to connect the filter system to a pump, the tab portions extending outwardly at a right angle away from the receiving portions. The top portion and the bottom portion each may include two tab portions. Each of the receiving portions may include a tray-shaped portion perpendicular to the top portion to receive and lock a filter in place at its sides when the filter is positioned horizontally relative to the top portion. The bottom portion may include a ledge portion to receive the bottom side of a filter when it is locked into position in the filter system. The two tab portions of the top portion may be positioned and spaced to be parallel with the two tab portions of the bottom portion. Each of the receiving portions may include a tray-shaped portion positioned perpendicular to the top portion to receive and lock a filter in place its sides when the filter is positioned horizontally related to the top portion. Each of the tray-shaped portions of the receiving portions may extend in a direction opposite the positioning of the tab portions.

In an additional embodiment of the present disclosure, a removable radiator bracket filter system may comprise a top portion and a bottom portion in parallel to each other with receiving portions in parallel to each other and joining with the top portion and the bottom at a right angle, the top portion, the bottom portion and the receiving portions forming a frame, wherein each of the receiving portions, the top portion and the bottom portion may include tab portions having apertures to connect the filter system to a pump. The tab portions on the top portion may extend outwardly at a right angle from the top portion and the tab portions on the bottom portion may extend outwardly at a right angle from the bottom portion, and wherein the tab portions on the top portion may be positioned parallel to the tab portions on the bottom portion. The receiving portions may further comprise extension portions that may extend outwardly at a right angle relative to the receiving portions, wherein the extension portions may include the tab portions positioned at an end of each of the extension portions opposite the point of attachment between the extension portions and the receiving positions. The tab portions on the extension portions may further comprise apertures to connect the filter system to the pump, wherein the apertures on one of the extension portions may be positioned parallel to the apertures on another one of the extension portions.

### BRIEF DESCRIPTION OF THE DRAWINGS

For a more complete understanding of this disclosure, reference is now made to the following description, taken in conjunction with the accompanying drawings, in which:

FIG. 1 depicts a left perspective view of an old-style filter system including a filter according to an embodiment of the present disclosure;

FIG. 2 depicts a bottom side view of a new-style filter system according to an embodiment of the present disclosure;

FIG. 3 depicts a perspective view of a new-style filter system according to an embodiment of the present disclosure;

FIG. 4 depicts a backside view of a new-style filter system according to an embodiment of the present disclosure;

FIG. 5 depicts an elevated top view of a new-style filter system according to an embodiment of the present disclosure;

FIG. 6 depicts a back view of a combo-style filter system according to an embodiment of the present disclosure;

FIG. 7 depicts a rotated back view of a combo-style filter system according to an embodiment of the present disclosure; and

FIG. 8 depicts insertion of a filter into a filter system according to an embodiment of the present disclosure.

### DETAILED DESCRIPTION

Filter systems according to embodiments of the present disclosure may be provided in several forms—old-style, new-style and combo-style—to accommodate the various types of radiator pumps that may be attached to such filter systems. As will be described below, the structure of filter systems according to embodiments of the present disclosure may provide a user with means to more easily insert and remove a filter from the filter system, thereby allowing a user to more regularly clean and/or replace the filters to avoid overheating, for example, in a radiator pump. Use of filter systems according to embodiments of the present disclosure also may help to avoid undesirable slow-downs and/or to minimize downtime in use of the radiator pumps when cleaning may be needed.

It should be appreciated that filter systems according to embodiments of the present disclosure may generally be formed using metal, such as galvanized steel. However, other materials, such as composites, may be used to form filter systems according to embodiments of the present disclosure provided that the materials may withstand temperatures in the range of approximately 250 degrees Fahrenheit—a typical operating range for pumps to which filter systems according to embodiments of the present disclosure may be attached.

Regardless of the filter system, each of the filter systems may be utilized with a variety of filters and pumps according to embodiments of the present disclosure. Filters, for example, may be customizable to fit into filter systems according to embodiments of the present disclosure. Pumps that may be utilized with filter systems formed according to embodiments of the present disclosure may include, but are not necessarily limited to, vacuum pumps such as Busch RA0630, Airtech L/H 630-G1, and/or Squire Cogswell SD25-N or S25-N. However, it should be appreciated that other pumps may be fitted for use with these filter systems without departing from the present disclosure. Such pumps may be medium vacuum or may provide deeper vacuum. Pumps also may be flooded in different manners and/or contain varying numbers of vanes without departing from the present disclosure.

Filter systems according to embodiments of the present disclosure may be used in a variety of industries including, but not limited to, chemical, pharmaceutical, packaging, food processing, injection molding, thermoforming, healthcare, and/or other processing-related applications. However, it should be appreciated that these filter systems may be used in other industries or for other applications where reduction or trapping of contaminants may be needed without departing from the present disclosure.

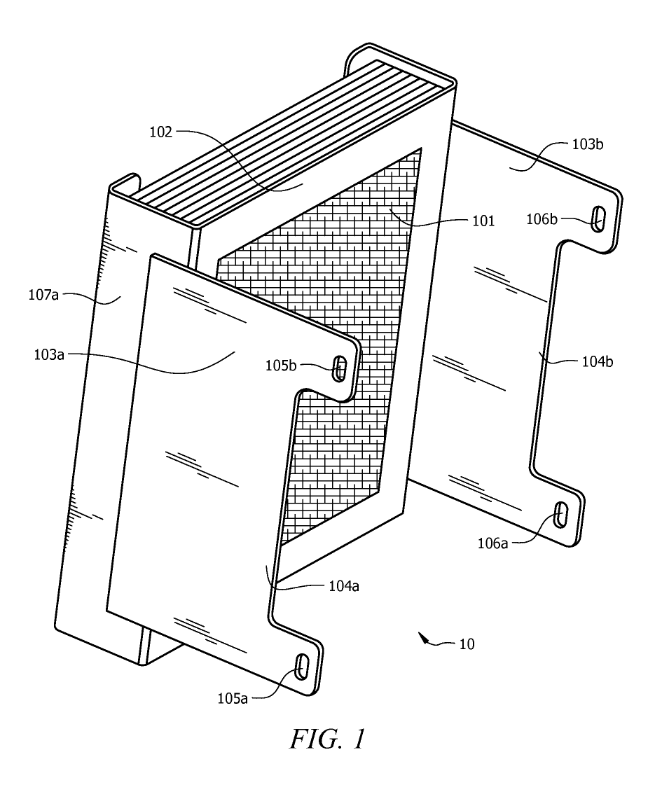

FIG. 1 depicts a left perspective view of old-style filter system 10 including filter 101 according to an embodiment of the present disclosure. Filter system 10 may include body 102 having an opening at a top edge through which filter 101 may be received. A bottom edge of body 102 may be solid, such as in a tray formation, to receive filter 101 and avoid filter 101 sliding through body 102. Extension portions 103a, 103b may protrude from receiving portions 107a, 107b (not shown) relative to the left and right edges of body 102. Receiving portions 107a, 107b may be tray or ledge-shaped to receive sides of filter 101. Each of extension portions 103a, 103b may include respective U-shaped curved portions 104a, 104b at the ends of extension portions 103a, 103b opposite body 102. Aperture tabs 105a, 105b may be positioned at the end points of U-shaped curved portion 104a. Similarly, apertures 106a, 106b may be positioned at the end points of U-shaped curved portion 104b. Each of aperture tabs 105a, 105b, 106a, 106b may be used to attach filter system 10 to a pump (not shown) such that filter 101 may be removed from filter system 10, cleaned, and then re-placed into filter system 10. While the apertures in the aperture tabs are depicted as somewhat circular in shape, it should be appreciated that the apertures may be formed in any shape to attach to a desired pump without departing from the present disclosure.

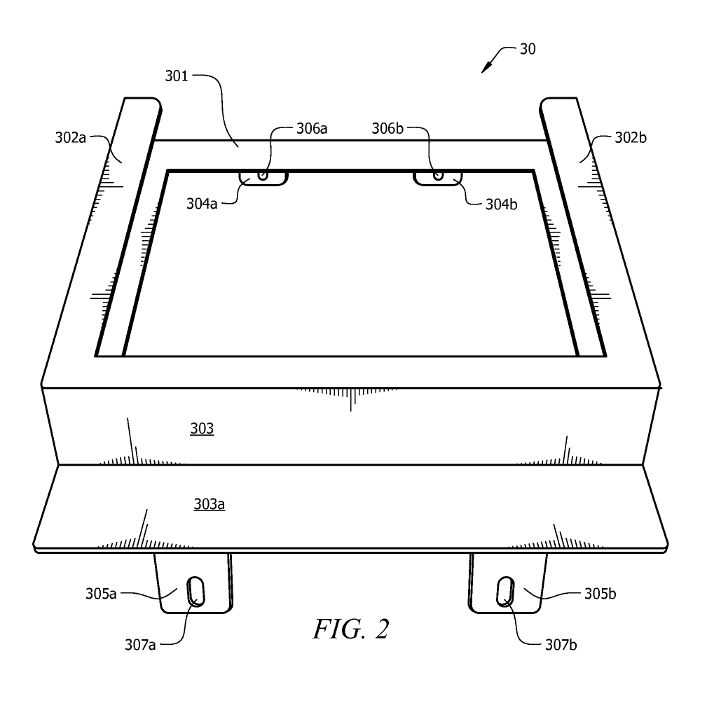

FIG. 2 depicts a bottom side view of new-style filter system 30 according to an embodiment of the present disclosure. Filter system 30 may include a frame formed from top portion 301. Receiving portions 302a, 302b may be attached to the ends of top portion 301 at a right angle relative to top portion 301. Top portion 301 may include tab portions 304a, 304b extending outwardly at a right angle away from receiving portions 302a, 302b. Tab portions 304a, 304b may respectively include apertures 306a, 306b that may be utilized for connecting filter system 30 to a pump (not shown). Receiving portions 302a, 302b may each include a tray-shaped portion perpendicular to top portion 301 to receive and lock a filter in place at its sides when the filter may be positioned horizontally relative to top portion 301.

Bottom portion 303 may be attached to ends of receiving portions 302a, 302b opposite the end points that may be attached to top portion 301. Bottom portion 303 may include ledge portion 303a such that it may receive the bottom side of the filter when it is locked into position in filter system 30. Bottom portion 303 may include tab portions 305a, 305b extending outwardly at a right angle away from receiving portions 302a, 302b. Tab portions 305a, 305b may respectively include apertures 307a, 307b that may be utilized for connecting filter system 30 to a pump (not shown). Tab portions 304a, 304b may be spaced apart on top portion 301 in a manner such that they may be parallel to tab portions 305a, 305b that may be positioned on bottom portion 303.

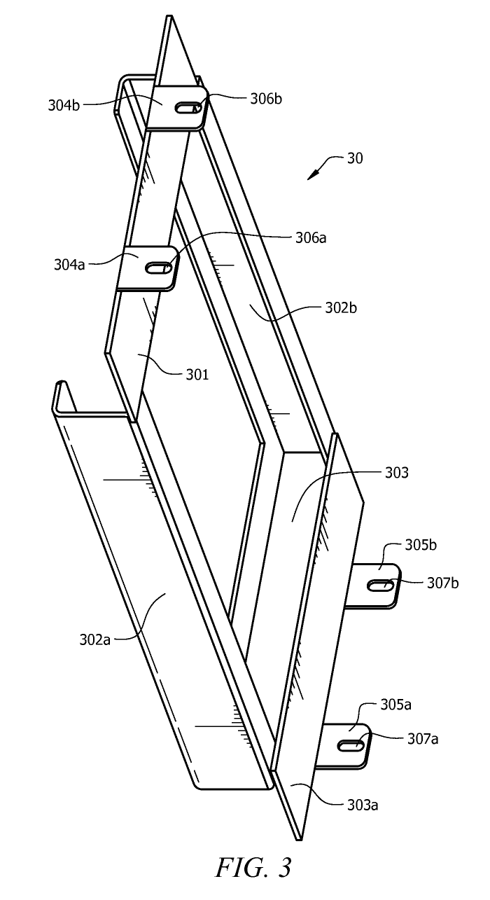

FIG. 3 depicts a perspective view of new-style filter system 30 according to an embodiment of the present disclosure. In this embodiment, tab portions 304a, 304b attached to top portion 301 as well as tab portions 305a, 305b attached to bottom portion 303 may be more easily viewable. As in FIG. 2, tab portions 304a, 304b may be spaced apart on top portion 301 in a manner such that they may be parallel to tab portions 305a, 305b respectively that may be positioned on ledge portion 303a of bottom portion 303. Tab portions 304a, 304b may include apertures 306a, 306b respectively. Similarly, tab portions 305a, 305b may include apertures 307a, 307b respectively. Further, receiving portions 302a, 302b may each include a tray-shaped portion perpendicular to top portion 301 to receive and lock a filter in place at its sides when the filter may be positioned horizontally relative to top portion 301 according to embodiments of the present disclosure. In this embodiment, the tray-shaped portions of receiving portions 302a, 302b may extend in a direction opposite the positioning of tab portions 304a, 304b as well as tab portions 305a, 305b.

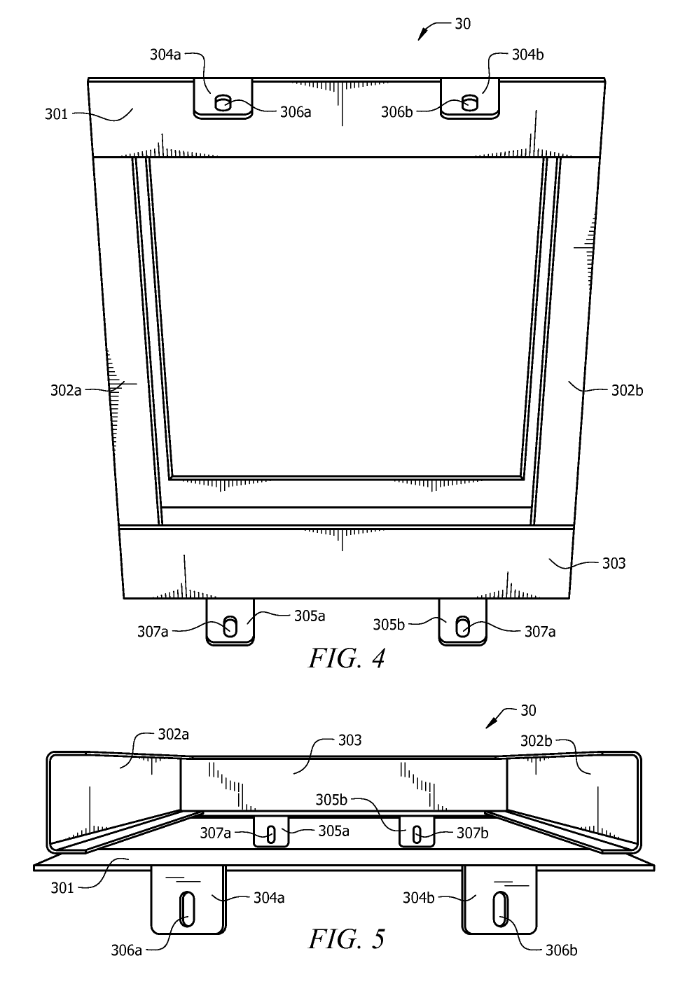

FIG. 4 depicts a backside view of new-style filter system 30 according to an embodiment of the present disclosure. In this embodiment, filter system 30 has been rotated such that the shape of bottom portion 303 may be more easily viewable. Top portion 301 and bottom portion 303 may be positioned parallel to one another and may be attached to each other with receiving portions 302a, 302b at right angles respectively to form a frame. Top portion 301 may include tab portions 304a, 304b extending outwardly at a right angle away from receiving portions 302a, 302b. As in FIGS. 2-3, tab portions 305a, 305b extending outwardly at a right angle away from receiving portions 302a, 302b, wherein the tab portions may include apertures 307a, 307b that may extend outwardly from bottom portion 303. Similarly, tab portions 304a, 304b including apertures 306a, 306b may extend outwardly from top portion 301. Each of the apertures on the tab portions may be utilized for connecting filter system 30 to a pump (not shown). Tab portions 304a, 304b may be spaced apart on top portion 301 in a manner such that they may be parallel to tab portions 305a, 305b that may be positioned on bottom portion 303.

Receiving portions 302a, 302b may be positioned such that they may connect top portion 301 to bottom portion 303 forming a frame. Receiving portions 302a, 302b may be formed in the shape similar to a tray that may be perpendicular to top portion 301 and extending at a right angle away from the backside of filter system 30. Bottom portion 303 may include a tray-shaped ledge portion that may receive the bottom side of a filter. Such receiving portions and bottom portion may receive and lock a filter into place on its sides and at its bottom respectively when a filter may be placed horizontally in the frame of filter system 30.

FIG. 5 depicts an elevated top view of new-style filter system 30 according to an embodiment of the present disclosure. Filter system 30 may include a frame formed from top portion 301. Receiving portions 302a, 302b may be attached to the ends of top portion 301 at a right angle relative to top portion 301 and may be formed as shallow trays for receiving the sides of a filter that may be inserted into filter system 30 and locking the filter into place when it may be positioned horizontally relative to top portion 301. Receiving portions 302a, 302b may be formed as shallow trays or ledges for receiving the sides of a filter.

Top portion 301 may include tab portions 304a, 304b extending outwardly at a right angle away from receiving portions 302a, 302b. Tab portions 304a, 304b may respectively include apertures 306a, 306b that may be utilized for connecting filter system 30 to a pump (not shown).

Bottom portion 303 may be attached to ends of receiving portions 302a, 302b opposite the end points that may be attached to top portion 301. Bottom portion 303 may include a ledge portion such that it may receive the bottom side of the filter when it is locked into position in filter system 30. Bottom portion 303 may include tab portions 305a, 305b extending outwardly at a right angle away from receiving portions 302a, 302b. Tab portions 305a, 305b may respectively include apertures 307a, 307b that may be utilized for connecting filter system 30 to a pump (not shown). Tab portions 305a, 305b may be positioned such that they extend outwardly at a right angle relative to bottom portion 303. Similarly, tab portions 304a, 304b may be attached to and extend outwardly at a right angle relative to top portion 301. Tab portions 304a, 304b may be spaced apart on top portion 301 in a manner such that they may be parallel to tab portions 305a, 305b respectively that may be positioned on bottom portion 303.

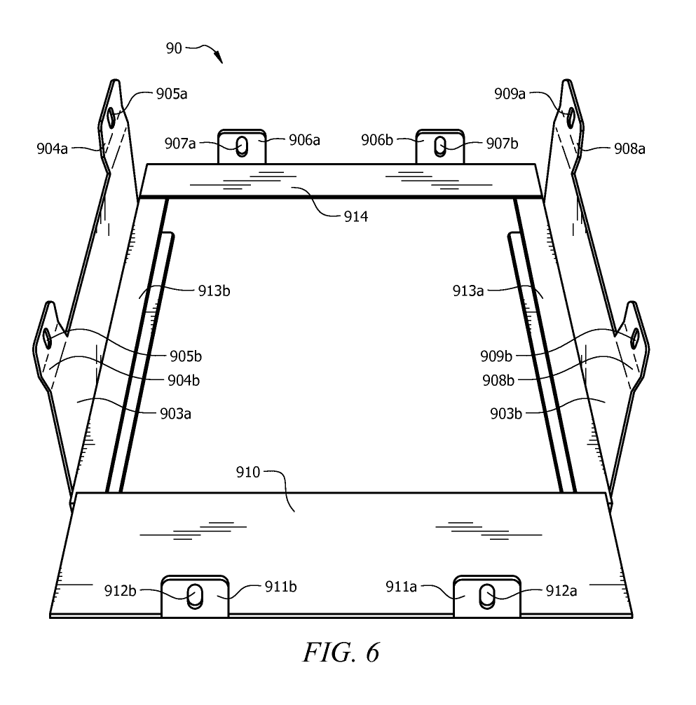

Combo-style filter system 90 may combine features, namely the tab portions, from each of old-style filter system 10 as well as new-style filter system 30. FIG. 6 depicts a back view of combo-style filter system 90 according to an embodiment of the present disclosure. In this embodiment, bottom portion 910 may be more easily viewable and may include a ledge or tray portion (not shown) as well as an extension portion that may include tab portions 911a, 911b that may extend outwardly from bottom portion 910 at a right angle. Similarly, top portion 914 may be more easily viewable and may include tab portions 906a, 906b that may extend outwardly from top portion 914 at a right angle. Tab portions 906a, 906b may include apertures 907a, 907b respectively that may be used as attachment points to connect filter system 90 to a pump (not shown). It should be appreciated tab portions 912a, 912b and tab portions 906a, 906b may be positioned on bottom portion 910 and top portion 914 respectively such that the tab portions may be parallel to one another. Similarly, apertures 912a, 912b on tabs 911a, 911b and apertures 907a, 907b on tab portions 906a, 906b may be positioned such that they are parallel to one another. Such apertures may be used to attach filter system 90 to a pump (not shown).

Receiving portions 913a, 913b may be positioned such that they are each attached at an end point of each of bottom portion 910 and top portion 914. Receiving portions 913a, 913b may assume a tray-shaped structure such that they may receive the sides of a filter being placed into filter system 90. Receiving portions 913a, 913b respectively may include extension portions 903a, 903b that may extend outwardly at a right angle relative to receiving portions 913a, 913b. Extension portion 903a may include tab portions 904a, 904b that may be positioned at end points opposite the attachment area between extension portion 903a and receiving portion 913b. Tab portions 904a, 904b may include apertures 905a, 905b respectively that may be used as attachment points to connect filter system 90 to a pump (not shown). Similarly, extension portion 903b may include tab portions 908a, 908b that may be positioned at ends points opposite the attachment area between extension portion 903b and receiving portion 913a. Tab portions 908a, 908b may include apertures 909a, 909b respectively that may be used as attachment points to join filter system 90 with a pump (not shown).

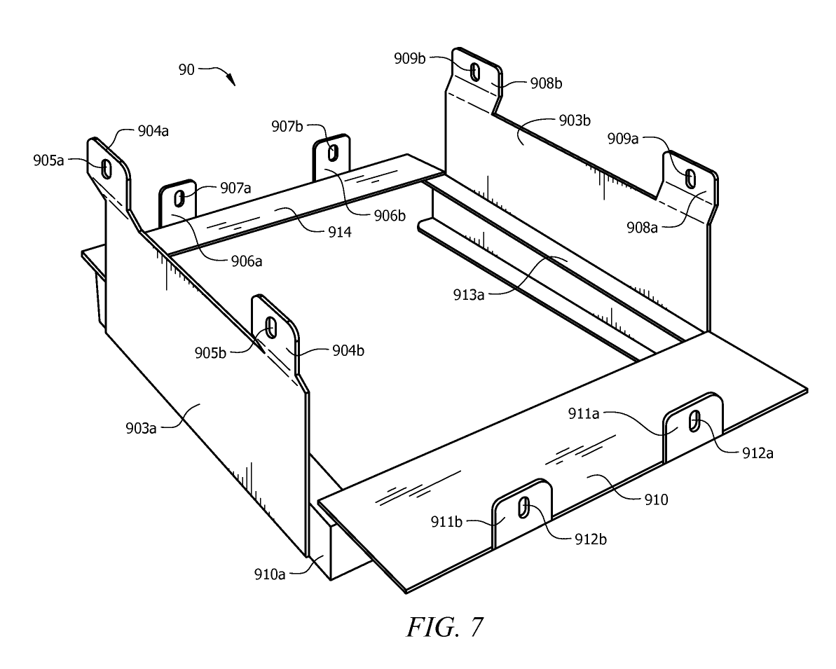

FIG. 7 depicts a rotated back view of combo-style filter system 90 according to an embodiment of the present disclosure. In this embodiment of filter system 90, tray-shaped portion 910a of bottom portion 910 may be more easily viewable. Tray-shaped portion 910a may be attached at its end points to extension portions 903a, 903b. Bottom portion 910 may extend from tray-portion 910a at a perpendicular angle relative to tray-portion 910a. Bottom portion 910 may include tabs 911a, 911b that may extend from bottom portion 910 at a perpendicular angle relative to bottom portion 910. Tabs 911a, 911b may include apertures 912a, 912b respectively that may provide attachment points to connect filter system 90 to a pump (not shown). Top portion 914 may include tab portions 906a, 906b that extend outwardly at a right angle from top portion 914. Tab portions 906a, 906b may each include apertures 907a, 907b respectively that may be used as attachment points to connect filter system 90 to a pump (not shown). Tab portions 906a, 906b and tab portions 911a, 911b may be respectively positioned with respect to top portion 914 and bottom portion 910 such that they are parallel to each other.

Receiving portions 913a, 913b (not shown) may be positioned such that they are each attached at an end point of each of bottom portion 910 and top portion 914. Receiving portions 913a, 913b may assume a tray-shaped structure such that they may receive the sides of a filter being placed into filter system 90. Receiving portions 913a, 913b respectively may include extension portions 903a, 903b that may extend outwardly at a right angle relative to receiving portions 913a, 913b. Extension portion 903b may include tab portions 908a, 908b at each end point opposite to the attachment point between extension portion 903b and receiving portion 913a. Tab portions 908a, 908b may include apertures 909a, 909b that may be used as attachment points to connect filter system 90 to a pump (not shown). Similarly, extension portion 903a may include tab portions 904a, 904b at each end point opposite to the attachment point between extension portion 903a and a receiving portion (not shown). Tab portions 904a, 904b may each include apertures, such as 905a and 905b respectively, that may be used as attachment points to connect filter system 90 to a pump (not shown).

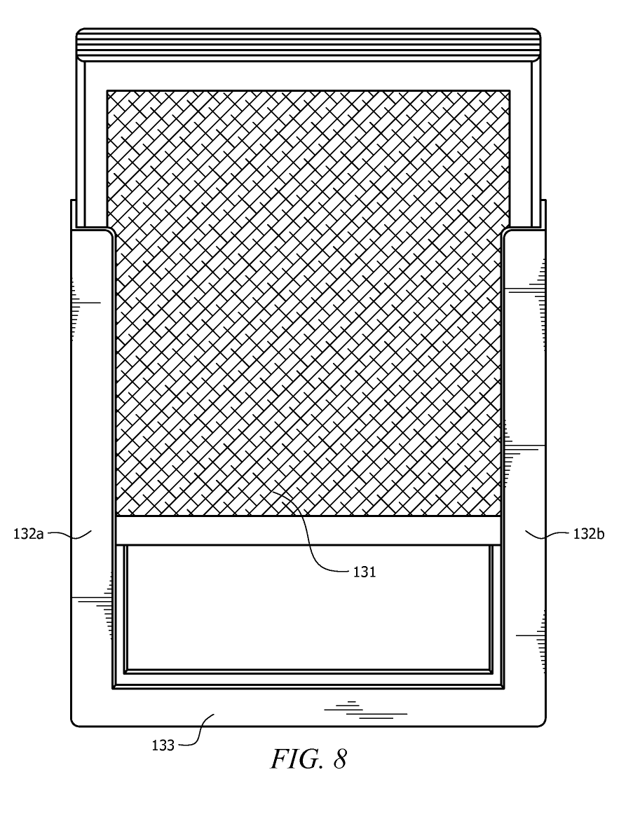

FIG. 8 depicts insertion of filter 131 into filter system 100 according to an embodiment of the present disclosure. From this front view, filter system 100 may be an old-style filter system, new-style filter system, or a combo-style filter system without departing from the present disclosure. Receiving portions 132a, 132b may be formed to connect with bottom portion 133 to receive filter 131 and lock it into place. Receiving portions 132a, 132b as well as bottom portion 133 may be shaped in a tray or ledge type manner such that filter 131 may be inserted into filter system 100 such that it may not easily slide out of filter system 100 until a user removes it.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A removable radiator bracket filter system comprising:
a body having a top edge with an opening through which a filter is received, and receiving portions joining with the top edge and a bottom edge to form a frame, the receiving portions having a ledge-shape to receive the sides of the filter and including extension portions that protrude from the receiving portions.

2. The removable radiator bracket filter system of claim 1 wherein the bottom edge is shaped in a tray formation to receive the filter.

3. The removable radiator bracket filter system of claim 1 wherein each of the extension portions includes a U-shaped curved portion at the end opposite the joining point between the receiving portion and the extension portion.

4. The removable radiator bracket filter system of claim 3 wherein each of the extension portions includes aperture tabs positioned on opposing sides of the U-shaped curved portion to attach the filter system to a pump.

5. The removable radiator bracket filter system of claim 4 wherein the pump is a vacuum pump.

6. A removable radiator bracket filter system comprising:
a top portion and a bottom portion in parallel to each other with receiving portions in parallel to each other and joining with the top portion and the bottom at a right angle, the top portion, the bottom portion and the receiving portions forming a frame,
wherein the top portion and the bottom portion each include tab portions having apertures to connect the filter system to a pump, the tab portions extending outwardly at a right angle away from the receiving portions.

7. The removable radiator bracket system of claim 6, wherein the top portion and the bottom portion each include two tab portions.

8. The removable radiator bracket system of claim 6, wherein each of the receiving portions includes a tray-shaped portion perpendicular to the top portion to receive and lock a filter in place at its sides when the filter is positioned horizontally relative to the top portion.

9. The removable radiator bracket system of claim 6 wherein the bottom portion includes a ledge portion to receive the bottom side of a filter when it is locked into position in the filter system.

10. The removable radiator bracket system of claim 7 wherein the two tab portions of the top portion are positioned and spaced to be parallel with the two tab portions of the bottom portion.

11. The removable radiator bracket system of claim 6, each of the receiving portions including a tray-shaped portion positioned perpendicular to the top portion to receive and lock a filter in place its sides when the filter is positioned horizontally related to the top portion.

12. The removable radiator bracket system of claim 11 wherein each of the tray-shaped portions of the receiving portions extend in a direction opposite the positioning of the tab portions.

13. A removable radiator bracket filter system comprising:
a top portion and a bottom portion in parallel to each other with receiving portions in parallel to each other and joining with the top portion and the bottom at a right angle, the top portion, the bottom portion and the receiving portions forming a frame,
wherein each of the receiving portions, the top portion and the bottom portion include tab portions having apertures to connect the filter system to a pump.

14. The removable radiator bracket filter system of claim 13 wherein the tab portions on the top portion extend outwardly at a right angle from the top portion and the tab portions on the bottom portion extend outwardly at a right angle from the bottom portion, and
wherein the tab portions on the top portion are positioned parallel to the tab portions on the bottom portion.

15. The removable radiator bracket filter system of claim 13, the receiving portions further comprising:
extension portions that extend outwardly at a right angle relative to the receiving portions, wherein the extension portions include the tab portions positioned at an end of each of the extension portions opposite the point of attachment between the extension portions and the receiving positions.

16. The removable radiator bracket filter system of claim 15, the tab portions on the extension portions further comprising apertures to connect the filter system to the pump, wherein the apertures on one of the extension portions are positioned parallel to the apertures on another one of the extension portions.
